(19) United States
(12) Patent Application Publication
(10) Pub. No.: US 2010/0103021 A1
(43) Pub. Date: Apr. 29, 2010

(54) METHOD AND RADAR ARRANGEMENT FOR MONITORING A MONITORING AREA

(76) Inventor: Ralph Mende, Brauschweig (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/516,034

(22) PCT Filed: Nov. 13, 2007
(86) PCT No.: PCT/DE2007/002042

§ 371 Date: Dec. 17, 2009

(30) Foreign Application Priority Data
Nov. 24, 2006 (DE) 10 2006 056 111.2

(51) Int. Cl. G01S 13/56

(52) U.S. Cl. 342/28

(57) ABSTRACT

In the case of a radar arrangement for monitoring a monitoring area (1) having a radar transmitter (in 3) which continuously emits a measurement signal, having a radar receiver (in 3) for the measurement signal reflected from a moving object (6) and having an evaluation device for evaluation of a Doppler frequency, and improvement is achieved in object identification and a reduction is achieved in false alarms by providing at least one reflector (4) in the emission area of the radar transmitter (in 3), which reflects a radar signal emitted from the radar transmitter (in 3) to the radar receiver (in 3), by the evaluation of the Doppler frequency being periodically interrupted, and by the capability to switch the evaluation device, during the interruption, to evaluation of the existence or strength of the radar signal received by the radar receiver (in 3).

The invention relates to a method for monitoring a monitoring area by continuous emission of a measurement signal with a radar transmitter and reception of a received signal, which has been reflected from a moving object, by a radar receiver and evaluation of a Doppler frequency component in the received signal.

The invention also relates to a radar arrangement for monitoring a monitoring area with a radar transmitter which emits a measurement signal continuously, a radar receiver for the measurement signal which has been reflected from a moving object and an evaluation device for evaluation of a Doppler frequency.

In many cases, it is necessary to monitor a safety-relevant monitoring area to determine whether unauthorized personnel are passing through it. Monitoring areas such as these protect, for example, a building against entry by unauthorized personnel or—in the case of a prison—produce an alarm in the event of break-out attempts.

Since the normally used optical sensors in the form of motion sensors cause numerous false alarms and, furthermore, are sensitive to weather through the influence of fog, rain, snowfall, etc. when the monitoring area is in the open air, it is known for radar signals to be used for monitoring. A radar transmitter is accordingly installed in the monitoring area, whose emitted radar beams cover the monitoring area or a part of it. Radar beams reflected from objects in the monitoring area are received and evaluated by a radar receiver which is in general combined with the radar transmitter. Since a monitoring area in general contains numerous, fixed installed objects which reflect radar beams, the only objects which are detected as being relevant are those which are moving. An evaluation stage is connected to the radar receiver for this purpose, and evaluates Doppler frequency components caused by the movement of the object.

If a monitoring region cannot be monitored by a single radar transmitter, a plurality of radar transmitters can be arranged in the form of a chain, such that a second radar transmitter continues the monitoring area of the first radar transmitter. By way of example, this makes it possible to monitor the entire boundary of a prison.

It has been possible to drastically reduce the number of false alarms, in comparison to previous optical or infrared motion sensors, by the use of radar arrangements. Nevertheless, false alarms are still possible by virtue of the system design, for example as a result of small animals, such as rabbits or relatively large birds, etc. moving in the monitoring area. In principle, it is possible to achieve a reduction in the false alarms by greater technical complexity at the radar transmitter end and in the evaluation devices, but the financial outlay required to do this is not consistent with practical implementation of solutions such as these.

The present invention is therefore based on the object of reducing the number of false alarms of a radar monitoring installation without causing any significant increase in the complexity of the radar arrangement.

According to the invention, this object is achieved by a monitoring method of the type mentioned initially, characterized in that the evaluation of the Doppler frequency component is periodically interrupted, in that at least one reflector is used at a defined position in order to reflect the measurement signal, which has been transmitted by the radar transmitter, to the radar receiver, and in that a check is carried out during the interruption of the evaluation of the Doppler frequency component, to determine whether and with what strength a signal, which has been reflected from the reflector, of the radar transmitter is being received by the radar receiver.

The object is also achieved by a Doppler radar arrangement of the type mentioned initially, in that at least one reflector is provided in the emission area of the radar transmitter and reflects a radar signal, which has been emitted from the radar transmitter, towards the radar receiver, in that the evaluation of the Doppler frequency is periodically interrupted and in that, during the interruption, the evaluation device can be switched to evaluation of the existence or strength of the radar signal received by the radar receiver.

According to the present invention, the radar arrangement is predominantly operated in the conventional manner for detection of moving objects by evaluation of the Doppler frequency component. In order to verify the detection of the moving objects, the installation is periodically switched and is operated with appropriately installed reflectors in the form of a radar light barrier. Apart from the installation of the reflectors, the radar arrangement according to the invention does not require any significant additional hardware complexity since the conventional radar arrangement is additionally used for the function of a radar light barrier.

If the radar transmitter and the at least one associated reflector are suitably installed, the light barrier function makes it possible to distinguish between moving small animals and moving people in that, for example, the reflected beam which carries out the light barrier function runs at a height of 1 m above the ground, which means that the beam is normally not interrupted by small animals.

A plurality of reflectors are preferably arranged in the emission area of the radar transmitter, thus resulting in a plurality of light barrier functions for one radar transmitter. In this case, the plurality of reflected beams can be passed to a common radar receiver and can be evaluated as a sum signal, or the receiver can be designed to receive a plurality of reflected beams separately, which can then also be evaluated separately.

If the monitoring area is being monitored by a plurality of radar transmitters, it is expedient to design the corresponding radar light barriers in the same manner, by arranging a reflector for a first radar transmitter at the location of a second radar transmitter, which continues the monitoring area of the first radar transmitter.

The light barrier function according to the invention furthermore has the advantage that stationary objects, that is to say people who are not moving at that time, are also identified if they are located in the area of one of the radar light barriers.

It is possible without any problems for the radar transmitter to continue to transmit its previous radar signal continuously while switched to the light barrier function. Alternatively, the type of emitted radar signal can also be changed after switching, in order to allow the emitted intensity to be identified better.

In one preferred embodiment of the invention, the radar transmitter is designed to emit a radar signal at a frequency which changes in a defined manner during the interruption of the evaluation of the Doppler frequency. The changing frequency can in this case preferably be a frequency ramp which rises or falls continuously and with a uniform gradient. Since, in this case, the signal which is received after reflection is at a different frequency to the emitted radar signal, defined detection of the received radar signal is possible, particularly when the radar receiver is designed to mix the received radar signal with the emitted radar signal. The mixing process results in a signal at a difference frequency, which is constant and already known by virtue of the defined position of the reflector, as a result of which the radar signal reflected from the reflector can be distinguished from other radar signals which have been reflected from reflectors which are arranged elsewhere and, for example, are randomly distributed.

The periodic switching of the radar installation takes place in accordance with the respective monitoring requirement. An interruption frequency of 1 to 10 times per second appears to be advantageous for many applications.

The ratio of the monitoring of the moving object with the evaluation of the Doppler frequency to the light barrier function is preferably between 3:1 and 6:1 in time. For example, the duration of the monitoring of the moving object may be 100 ms, with the light barrier function then in each case being switched to be effective for 20 ms, thus resulting in a ratio of 5:1, and with the interruption occurring approximately 8 times per second.

When using a frequency ramp for the light barrier operation, frequency modulation (increase in the frequency) by 75 MHz can be carried out during the phase (for example of 20 ms) in which the light barrier function is being transmitted. If a reflector is located at a defined distance position of 50 m and the emitted radar signal frequency rises linearly, the received signal will be separated in frequency from the currently emitted signal by 1.25 kHz. If the received signal is mixed with the emitted signal in the radar receiver, this thus results in a spectral line at the difference frequency of 1.25 kHz. The reflection from the reflector at the defined position can therefore be distinguished from other, random reflections during light barrier operation.

Within the scope of the invention, it is, of course, quite possible for the monitoring of the moving object to be carried out using, for example, more complex measurement signals in order to obtain additional information about the range of the object, the velocity of the object, the angular velocity of movement, etc., when this is considered worthwhile or necessary.

The invention will be explained in more detail in the following text with reference to exemplary embodiments which are illustrated in the drawing, in which:

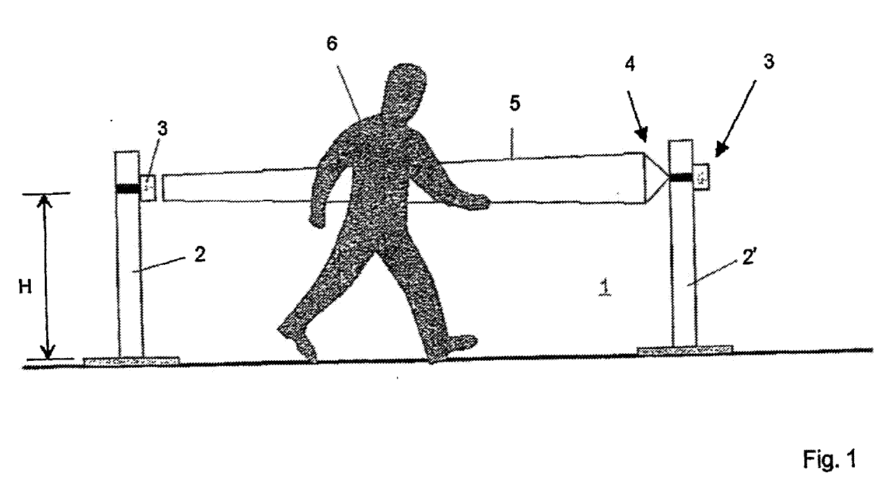

FIG. 1 shows a schematic illustration of a radar arrangement according to the invention, illustrating the light barrier function;

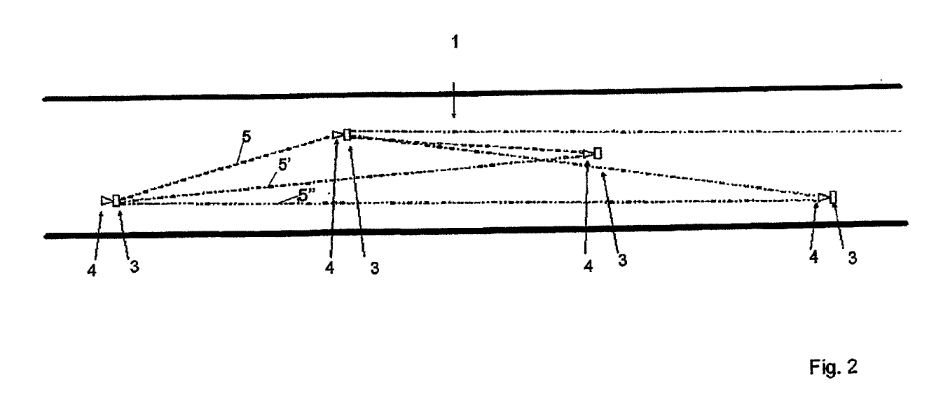

FIG. 2 shows a radar arrangement having a plurality of radar transmitters/receivers, which are arranged adjacent to one another in order to monitor an elongated monitoring area.

FIG. 1 shows a radar transmitter/receiver 3 which is mounted in a monitoring area 1 on an upright post 2 and emits a radar signal which largely covers the monitoring area 1. A reflector 4 is positioned on a further upright post 2′ in the emission area of the radar transmitter/receiver 3, which reflector focuses that part of the emitted radar signal that is incident on it to form a reflected beam 5, and transmits this back to the radar transmitter/receiver 3, in such a way that the reflected radar beam 5 forms a type of light barrier. A further radar transmitter/receiver 3 is mounted on the further upright post 2′, and is used to continue the monitoring area 1.

For the majority of the time, the radar transmitter/receiver 3 emits a measurement signal in order to receive reflected radar beams from a moving object, in this case from a person 6, and to identify this as a moving object 6 by evaluation of the Doppler frequency component. After a time of, for example, 100 ms, the installation is switched to a light barrier function, with a check being carried out in the radar transmitter/receiver 3 to determine whether or not a beam 5 which has been reflected from the correspondingly positioned reflector 4 is or is not being received. If the reflected beam 5 is not being received, then this indicates an interruption of the light barrier, which is formed by the reflected beam, by a person 6, thus confirming the information, as obtained from the evaluated Doppler frequency component, about a moving object, by means of the light barrier function.

Since the radar transmitter/receiver 3 is fitted at a suitable height H and the reflector 4 is expediently arranged at a corresponding suitable height, it is possible to differentiate between moving objects which do or do not reach the height H. By way of example, in the case of a detention center, it is possible to distinguish between the movement of a person 6 and the movement of small animals when, for example, the radar transmitter/receiver 3 is arranged at a height H of 1 m.

FIG. 2 schematically shows an elongated monitoring area 1 with four radar transmitters/receivers 3 which are arranged one behind the other in the longitudinal direction of the monitoring area 1 and each have a reflector 4 on their rear face. In the illustrated example, the radar transmitters/receivers are offset laterally with respect to one another, in such a way that the further radar transmitters/receivers 3 which are arranged one behind the other in the beam direction each reflect a beam 5, 5′, 5″ to the emitting radar transmitter/receiver 3. In a corresponding continuation of this arrangement, each radar transmitter/receiver 3 with the reflectors 4 of the radar transmitters/receivers which follow in the beam direction in each case forms three light barriers 5, 5′, 5″, as is indicated schematically in FIG. 2.

It is, of course, possible to arrange the reflectors 4 associated with a radar transmitter/receiver at different heights as well in order in this way to form obliquely rising or obliquely falling reflected beams 5, 5′, 5″ at different heights, thus making it more complicated to avoid the light barriers that are formed by the reflected beams 5, 5′, 5″.

As can be seen from FIG. 2, the radar transmitters/receivers 3 which are arranged one behind the other in the longitudinal direction of the monitoring area 1 are suitable for filling the entire monitoring area 1 both with regard to the measurement function on the basis of the Doppler frequency component and with regard to the light barrier function.

1. A method for monitoring a monitoring area (1) with a radar arrangement by continuous emission of a measurement signal with a radar transmitter (in 3) and reception of a received signal, which has been reflected from a moving object (6), by a radar receiver (in 3) and evaluation of a Doppler frequency component in the received signal, characterized in that the evaluation of the Doppler frequency component is periodically interrupted, in that at least one reflector (4) is used at a defined position in order to reflect the measurement signal, which has been transmitted by the radar transmitter (in 3), to the radar receiver (in 3), and in that a check is carried out during the interruption of the evaluation of the Doppler frequency component, to determine whether and with what strength a signal, which has been reflected from the reflector, of the radar transmitter (in 3) is being received by the radar receiver (in 3).

2. A radar arrangement for monitoring a monitoring area (1) with a radar transmitter (in 3) which emits a measurement signal continuously, a radar receiver (in 3) for the measurement signal which has been reflected from a moving object (6) and an evaluation device for evaluation of a Doppler frequency, characterized in that at least one reflector (4) is provided in the emission area of the radar transmitter (in 3) and reflects a radar signal, which has been emitted from the radar transmitter (in 3), towards the radar receiver (in 3), in that the evaluation of the Doppler frequency is periodically interrupted and in that, during the interruption, the evaluation device can be switched to evaluation of the existence or strength of the radar signal received by the radar receiver (in 3).

3. The radar arrangement as claimed in claim 2, characterized in that the reflector (4) is designed to reflect a focused beam (5) to the radar receiver (in 3).

4. The radar arrangement as claimed in claim 2, characterized in that a plurality of reflectors (4) are arranged in the emission area of the radar transmitter (in 3).

5. The radar arrangement as claimed in claim 4, characterized in that the plurality of reflected beams (5, 5′, 5″) are passed to a common radar receiver (in 3) and are evaluated as a sum signal.

6. The radar arrangement as claimed in claim 4, characterized in that the receiver (in 3) is designed to receive a plurality of reflected beams (5, 5′, 5″) separately.

7. The radar arrangement as claimed in claim 2, characterized in that a reflector (4) for a first radar transmitter is arranged at the location of a second radar transmitter, which continues the monitoring area of the first radar transmitter.

8. The radar arrangement as claimed in claim 2, characterized in that the radar transmitter (in 3) is designed to emit a radar signal at a frequency which changes in a defined manner during the interruption of the evaluation of the Doppler frequency.

9. The radar arrangement as claimed in claim 8, characterized in that the radar receiver (in 3) is designed to mix the received radar signal with the emitted radar signal
